(19) United States
(12) Patent Application Publication
(10) Pub. No.: US 2011/0039751 A1
(43) Pub. Date: Feb. 17, 2011

(54) CLEANING AND/OR TREATMENT COMPOSITIONS

(76) Inventors: PHILIP FRANK SOUTER, NORTHUMBERLAND (GB); EVA MARIA PEREZ-PRAT VINUESA, BRUSSELS (BE); ENRIQUE HERRERO ACERO, ZARAGOZA (ES); SINA PRICELIUS, GRAZ (AT); GEORG MAXIMILLIAN GUEBITZ, GRAZ (AT)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/913,053

(22) Filed: Oct. 27, 2010

Related U.S. Application Data
(63) Continuation of application No. 12/349,004, filed on Jan. 6, 2009.

(30) Foreign Application Priority Data
Jan. 11, 2008 (EP) EP08150189.2

(51) Int. Cl. C11D 3/60

(52) U.S. Cl. 510/226; 510/301; 510/320; 510/323; 510/305; 510/306

(57) ABSTRACT

This invention relates to compositions comprising certain cellobiose dehydrogenase enzymes and processes for making and using such compositions, including the use of such compositions to clean and/or treat a situs.

### CROSS-REFERENCES TO RELATED APPLICATIONS

This application is a continuation of U.S. application Ser. No. 12/349,004 filed Jan. 6, 2009, which claims priority to European Application No. EP 08150189.2 filed in the European Patent Office Jan. 11, 2008.

### FIELD OF INVENTION

This invention relates to compositions comprising cellobiose dehydrogenase enzymes and processes for making and using such compositions.

### BACKGROUND OF THE INVENTION

Enzymes can be used to improve the cleaning properties of compositions. Unfortunately, while there is a need for improved bleaching, a cleaning composition comprising an enzyme that provides effective and efficient bleaching has yet to be delivered.

Surprisingly, when a cellobiose dehydrogenase enzyme is incorporated, in accordance with the teaching of the present specification, in a cleaning composition, such composition delivers effective and efficient bleaching.

### SUMMARY OF THE INVENTION

This invention relates to compositions comprising certain cellobiose dehydrogenase enzymes and processes for making and using such compositions. When compositions that comprise certain cellobiose dehydrogenase enzymes are formulated in accordance with the teachings of the present invention, such compositions can provide effective and efficient bleaching.

### DETAILED DESCRIPTION OF THE INVENTION

### Definitions

As used herein, the term “cleaning composition” includes, unless otherwise indicated, granular or powder-form all-purpose or “heavy-duty” washing agents, especially laundry detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, laundry bars, mouthwashes, denture cleaners, car or carpet shampoos, bathroom cleaners; hair shampoos and hair-rinses; shower gels and foam baths and metal cleaners; as well as cleaning auxiliaries such as bleach additives, laundry additives or pre-treats and “stain-stick” or pre-treat types.

As used herein, the phrase “is independently selected from the group consisting of . . . ” means that moieties or elements that are selected from the referenced Markush group can be the same, can be different or any mixture of elements.

As used herein, the term “cellobiose dehydrogenase enzymes” or “CDH” refers to enzymes that are capable of oxidizing one or more of the below substrates:
a) oligosaccharides selected from the group consisting of cello-oligosaccharides, including a cello-oligosaccharide selected from the group consisting of cellobiose, cello-triose, cello-tetraose, cello-pentaose, cello-hexaose, cellodextrin and mixtures thereof, lactose, maltose, xylobiose and mixtures thereof;
b) amorphous cellulose;
c) cellulosic polymers including carboxy methyl cellulose; and
d) mixtures thereof,
   and having an EC. classification of EC. 1.1.99.18 or EC 1.1.5.1, the latter being a proteolytic product of EC 1.1.99.18, and may be described as cellobiose dehydrogenase, cellobiose oxidase, cellobiose dehydrogenase (quinone), cellobiose oxidoreductase, or cellobiose-quinone oxidoreductase.

As used herein, the term “cellobiohydrolase domain” refers to the catalytic domain of enzymes, having an EC classification of EC 3.2.1.91, or EC 3.2.1.150, and that are capable of liberating cellobiose from different polysaccharide substrates including cellulose or xyloglucans.

The expression “carbohydrate-binding-module” or “CBM” refers to a module with affinity to carbohydrate that targets its associated enzyme to the carbohydrate.

As used herein, the articles “a” and “an” when used in a claim, are understood to mean one or more of what is claimed or described.

As used herein, the terms “include”, “includes” and “including” are meant to be synonymous with the phrase “including but no limited to”.

Unless otherwise noted, all component or composition levels are in reference to the active level of that component or composition, and are exclusive of impurities, for example, residual solvents or by-products, which may be present in commercially available sources.

Unless otherwise noted, the cellobiose dehydrogenase enzymes of the present invention are expressed in terms of active protein level and are exclusive of impurities, for example, residual solvents or by-products, which may be present in commercially available sources.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Compositions

In one aspect, a composition that may comprise one or more adjunct ingredients and a cellobiose dehydrogenase enzyme said composition comprising, based on total composition weight, 0% weight % cellulase or said composition having a mass ratio of cellobiose dehydrogenase enzyme:cellulase of from about 0.01 to about 1,000,000, from about 0.02 to about 500,000, from about 0.05 to about 200,000 or even from about 0.1 to about 10,000 is disclosed.

In one aspect of such composition, said cellobiose dehydrogenase may have a minimum of 60% amino acid sequence identity with the wild-type cellobiose dehydrogenases derived from a microorganism selected from the group consisting of Myceliophtore thermophila, Phanerochaete chrysosporium, Trametes versicolor, Grifola frondosa, Neosartorya fischeri, Humicola insolens, Sclerotium rolfsii, Myriococcum thermophilum and combinations thereof.

In one aspect of such composition said cellobiose dehydrogenase may have a minimum of 70% amino acid sequence identity with any enzyme having a sequence corresponding to a sequence ID selected from the group consisting of SEQ. ID Nos. 1, 2, 3, 4, 5, 6, or 7.

In one aspect of such composition said cellobiose dehydrogenase enzyme may have a minimum of 85% amino acid sequence identity with a sequence corresponding to a sequence ID selected from the group consisting of SEQ. ID Nos. 1, 2, or amino acids 22 to 785 of SEQ. ID No. 3.

In one aspect of such composition, said composition may comprise a material selected from the group consisting of:
a) oligosaccharides selected from the group consisting of cello-oligosaccharides, including a cello-oligosaccharides selected from the group consisting of cellobiose, cello-triose, cello-tetraose, cello-pentaose, cello-hexaose, cellodextrin and mixtures thereof, lactose, maltose, xylobiose and mixtures thereof;
b) amorphous cellulose;
c) cellulosic polymers including carboxy methyl cellulose; and
d) mixtures thereof.

In one aspect of such composition, said cellobiose dehydrogenase enzyme may comprise a carbohydrate binding module, such as a cellulose-binding domain.

In one aspect of such composition said cellobiose dehydrogenase may comprise a cellobiose dehydrogenase domain and a cellobiohydrolase domain.

In one aspect of such composition said one or more adjunct ingredients may be selected from the group consisting of surfactants, builders, chelating agents, dye transfer inhibiting agents, dispersants, additional enzymes, and enzyme stabilizers, catalytic materials, bleaching agents, polymeric dispersing agents, clay soil removal/anti-redeposition agents, brighteners, suds suppressors, dyes, perfumes, structure elasticizing agents, fabric softeners, carriers, hydrotropes, processing aids, solvents, pigments, hueing agents, photobleaches, structurants, and mixtures thereof.

In one aspect of such composition, said one or more adjunct ingredients may comprise an enzyme. In one aspect of such composition said enzyme may be selected from the group consisting of peroxidases, proteases, lipases, phospholipases, cellobiohydrolases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases, or mixtures thereof. In one aspect of such composition, said enzyme may be selected from the group consisting of:
a.) lipases, such as lipases having greater than 90% amino acid sequence identity to SEQ. ID 8;
b.) alpha-amylases, such as alpha-amylases having greater than 90% amino acid sequence identity to SEQ. ID 9;
c.) endoglucanases, such as endoglucanases having greater than 90% amino acid sequence identity to SEQ. ID 10;
d.) proteases, including metalloproteases, neutral or alkaline serine proteases, such as subtilisins including those derived from Bacillus lentus, B. alkalophilus, B. subtilis, B. amyloliquefaciens, and mixtures thereof; and
e.) mixtures thereof.

In one aspect of such composition, said one or more adjunct ingredients may comprise a surfactant, such as a surfactant being selected from the group of:
a.) anionic surfactants including anionic surfactants selected from the group consisting of linear alkylbenzene-sulfonate (LAS), alcohol ethoxysulfate (AES), mid-branched alkyl sulfates (HSAS) and mixtures thereof;
b.) non ionic surfactants including alcohol ethoxylates, said alcohol ethoxylates, in one aspect, having a chain length of from 1 to 18 carbons;
c.) amine oxides
   and mixtures thereof.

In one aspect of such composition, said composition may comprise a polymer. In one aspect, said polymer may be selected from the group consisting of
a.) polyacrylates;
b.) maleic/acrylic acid copolymers;
c.) cellulose-derived polymers, including cellulose-derived polymers selected from the group consisting of carboxymethylcellulose, methyl hydroxyethylcellulose and mixtures thereof;
d.) polyethyleneimine polymers;
e.) soil release polymers, including co-polymers comprising two or more monomers selected from the group consisting of sulfo-isophthalate, ethylene terephthalate, oxyethyleneterephthalate and mixtures thereof; and
f.) mixtures thereof.

In one aspect of such composition, said composition may comprise a builder. In one aspect, said builder may be selected from the group consisting of
a.) citric acid;
b.) C₁₂-C₁₈ fatty acids;
c.) aluminosilicates, in one aspect a zeolite selected from the group consisting of Zeolite A, Zeolite X, Zeolite Y and mixtures thereof;
d.) sodium tripolyphosphate; and
e.) mixtures thereof.

In one aspect of such composition, said composition may comprise, based on total product weight, less than about 15%, less than about 10%, less than about 8% or even from about 0.01% to about 7% builder.

In one aspect of such composition, said composition may comprise a material selected from the group consisting of a photobleach, a fabric hueing agent and mixtures thereof. In one aspect said photobleach may be being selected from the group consisting of
a.) xanthene dyes and mixtures thereof;
b.) sulfonated zinc phthalocyanine, sulfonated aluminium phthalocyanine, Eosin Y, Phoxine B, Rose Bengal, C.I. Food Red 14 and mixtures thereof;
c.) water soluble phthalocyanine; and
d.) mixtures thereof;

and said fabric hueing agent may be selected from the group consisting of
a.) dyes, in one aspect said dyes being selected from the group consisting of small molecule dyes, polymeric dyes and mixtures thereof;
b.) dye-clay conjugates comprising at least one cationic/basic dye and a smectite; clay; and
c.) mixtures thereof;
   and mixtures thereof.

In one aspect, said composition may comprise a bleaching agent selected from one or more of the following:
a) a source of hydrogen peroxide;
b) a bleach activator, including tetraacetyl ethylene diamine (TAED) and/or nonanoyloxybenzene sulphonate (NOBS);
c) a pre-formed peracid;
d) a diacyl peroxide;
e) a tetraacyl peroxide; and
f) mixtures thereof.

In one aspect of such composition, said composition may comprise a bleach catalyst that is capable of accepting an oxygen atom from a peroxyacid and transferring the oxygen atom to an oxidizeable substrate.

In one aspect of the aforementioned compositions, any enzyme component may be encapsulated and/or provided in prill form.

In one aspect of the aforementioned compositions, such compositions may take any form, for example, a solid including a granule or powder or a fluid including a liquid, paste or gel.

In one aspect of the aforementioned compositions, such compositions may be cleaning composition and/or treatment compositions.

The compositions disclosed herein may have any acceptable combination of parameters described above in this section of the present specification entitled “Compositions”

Suitable cellobiose dehydrogenase enzymes for use in the compositions of the present specification include the cellobiose dehydrogenase enzymes described in the section of the present specification entitled “Suitable cellobiose dehydrogenase enzymes”

Without wishing to be bound by theory, compositions formulated in accordance with the teachings of the present specification are believed to be particularly effective at stain removal of bleachable soils such as fruit (e.g. blueberry), red wine, tea or coffee. Such compositions are believed to be particularly effective at providing whiteness and/or dingy cleaning benefits. Furthermore, it is believed that certain cellobiose dehydrogenase enzymes are unexpectedly stable in cleaning compositions and thus can provide cleaning compositions with such superior cleaning properties. Without wishing to be bound by theory, such cellobiose dehydrogenase enzymes are believed to be able to generate oxidizing species at the cotton fabric and/or soil surface and thereby impart superior cleaning than if the equivalent bleaching species are added in solution.

### Suitable Cellobiose Dehydrogenase Enzymes

Suitable cellobiose dehydrogenase enzymes can be isolated from one of Myceliophtore thermophila, Phanerochaete chrysosporium, Trametes versicolor, Grifola frondosa, Aspergillus Niger, Neosartorya fischeri, Humicola insolens, Sclerotium rolfsii and Myriococcum thermophilum. Examples of such enzymes are described in the literature in J. Biotechnology 78 (2000) 93-113, Applied and Environmental Microbiology, April 2001, p. 1766-1774, U.S. Pat. No. 6,033,981 and in Electroanalysis 19, 2-3, 2007, 172-180.

Suitable cellobiose dehydrogenase enzymes include haemoflavoproteins that in one aspect belong to EC Class 1.1.99.18 and are active under typical wash conditions.

Suitable cellobiose dehydrogenase enzymes may be protein engineered to improve their stability in detergents by techniques well known in the art including the ones described in U.S. Pat. No. 5,324,653 and U.S. Pat. No. 7,163,816 B2.

Suitable cellobiose dehydrogenase enzymes may have greater than 60%, or greater than 70% or greater than 80%, or greater than 90% or greater than 95% or greater than 98% amino acid sequence identity with the enzymes whose sequences are shown as SEQ. ID 1-7. For the purpose of the present invention the degree of identity between amino acid sequences is determined using the BLASTP algorithm (Basic Local Alignment Search Tool) and/or the BLAST 2 Sequences tool described in Tatusova & Madden (1999) FEMS Microb. Lett. 174(2):247-250 both freely available on the NCBI website whose web address is shown in parentheses (http://www.ncbi.nlm.nih.gov/BLAST/). The parameters used for sequence alignment are the default settings in the mentioned web site.

Suitable cellobiose dehydrogenases may contain a CBM such as a cellulose-binding domain.

Suitable cellobiose dehydrogenase enzymes may also be fused to a further catalytic domain having cellulolytic, hemicellulolytic, or cellobiohydrolase activity, optionally via a linker molecule.

The aforementioned enzymes can be provided either in the form of a low-dusting solid (typically a granule or prill) or as a stabilized liquid or as a protected liquid or encapsulated enzyme. Numerous techniques are described in the art to produce low-dusting solid forms of enzymes, including prilling, extrusion, spheronization, drum granulation and fluid bed spray coating and exemplified in U.S. Pat. No. 4,106,991; U.S. Pat. No. 4,242,219; U.S. Pat. No. 4,689,297, U.S. Pat. No. 5,324,649 and U.S. Pat. No. 7,018,821 B2. Liquid enzyme preparations may, for instance, be stabilized by adding a polyol such as propylene glycol, a sugar or sugar alcohol, lactic acid or boric acid according to established methods. Protected liquid enzymes or encapsulated enzymes may be prepared according to the methods disclosed in U.S. Pat. No. 4,906,396, U.S. Pat. No. 6,221,829 B1, U.S. Pat. No. 6,359,031 B1 and U.S. Pat. No. 6,242,405 B1.

### Adjunct Materials

While not essential for the purposes of the present invention, the non-limiting list of adjuncts illustrated hereinafter are suitable for use in the instant compositions and may be desirably incorporated in certain embodiments of the invention, for example to assist or enhance cleaning performance, for treatment of the substrate to be cleaned, or to modify the aesthetics of the cleaning composition as is the case with perfumes, colorants, dyes or the like. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, additional enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, perfumes, structure elasticizing agents, fabric softeners, carriers, hydrotropes, processing aids, solvents, hueing agents, structurants and/or pigments. In addition to the disclosure below, suitable examples of such other adjuncts and levels of use are found in U.S. Pat. Nos. 5,576,282, 6,306,812 B1 and 6,326,348 B1 that are incorporated by reference.

As stated, the adjunct ingredients are not essential to Applicants' compositions. Thus, certain embodiments of Applicants' compositions do not contain one or more of the following adjuncts materials: surfactants, builders, chelating agents, dye transfer inhibiting agents, dispersants, additional enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, solvents and/or pigments. However, when one or more adjuncts are present, such one or more adjuncts may be present as detailed below:

Bleaching Agents and Non-metal Bleach Catalysts—The cleaning compositions of the present invention may comprise one or more bleaching agents. Suitable bleaching agents other than bleaching catalysts include photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the subject cleaning composition. Examples of suitable bleaching agents include:

(1) preformed peracids: Suitable preformed peracids include, but are not limited to, compounds selected from the group consisting of percarboxylic acids and salts, percarbonic acids and salts, perimidic acids and salts, peroxymonosulfuric acids and salts, for example, Oxone®, and mixtures thereof. Suitable percarboxylic acids include hydrophobic and hydrophilic peracids having the formula R—(C═O)O—O-M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen;

(2) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof. When employed, inorganic perhydrate salts are typically present in amounts of from 0.05 to 40 wt %, or 1 to 30 wt % of the overall composition and are typically incorporated into such compositions as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and

(3) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NOBS, TAED or mixtures thereof.

(4) Suitable non-metal bleach catalysts and appropriate levels of such catalysts for use in the present compositions are disclosed in U.S. Pat. No. 7,169,744 B2 and USPA 2006/0287210 A1.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

Surfactants—The cleaning compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 1% to about 50% or even from about 5% to about 40% by weight of the subject composition.

Builders—The cleaning compositions of the present invention may comprise one or more detergent builders or builder systems. When a builder is used, the subject composition will typically comprise at least about 1%, from about 5% to about 60% or even from about 10% to about 40% builder by weight of the subject composition.

Builders include, but are not limited to, the alkali metal, ammonium and alkanolammonium salts of polyphosphates, alkali metal silicates, alkaline earth and alkali metal carbonates, aluminosilicate builders and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—The cleaning compositions herein may contain a chelating agent. Suitable chelating agents include copper, iron and/or manganese chelating agents and mixtures thereof. When a chelating agent is used, the subject composition may comprise from about 0.005% to about 15% or even from about 3.0% to about 10% chelating agent by weight of the subject composition.

Dye Transfer Inhibiting Agents—The cleaning compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Brighteners—The cleaning compositions of the present invention can also contain additional components that may tint articles being cleaned, such as fluorescent brighteners. Suitable fluorescent brightener levels include lower levels of from about 0.01, from about 0.05, from about 0.1 or even from about 0.2 wt % to upper levels of 0.5 or even 0.75 wt %.

Dispersants—The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Polymers—The compositions of the present invention can also contain one or more polymers. These would include soil release polymers & soil suspension polymers. This would include polymers commonly known in the art such as block polyesters according to U.S. Pat. No. 4,702,857 and sulfonated linear terephthalate ester oligomers according to U.S. Pat. No. 4,968,451, as well as ethoxylated tetraethylene pentaimine (EO₁₅₋₁₈) according to U.S. Pat. No. 4,597,898 and ethoxylated hexamethylene diamine available under the tradename LUTENSIT® from BASF and such as those described in WO 01/05874.

In one aspect, the soil release polymers may be co-polymers comprising two or more monomers selected from sulfo-isophthalate, ethylene terephthalate and oxyethyleneterephthalate, including those sold by Clariant under the names TexCare® SRA and TexCare® SRN tradenames, such as TexCare® SRA300 and TexCare® SRN100.

In a further aspect the polymers would include Poly ethtlene glycol/alkyl acetate co-polymers, including PEGVAc co-polymers such as those sold by BASF under the Sokalan tradename, e.g. Sokalan HP22.

In a further aspect the polymers would include cellulosic-based polymers such as amorphous cellulose and anionically and/or nonionically and/or cationically modified celluloses. Non-limiting examples of anionically suitable modified cellulose derivatives are the sodium or potassium salts of carboxymethyl cellulose, carboxyethyl cellulose, sulfoethyl cellulose, sulfopropyl cellulose, cellulose sulfate, phosphorylated cellulose, carboxymethyl hydroxyethyl cellulose, carboxymethyl hydroxypropyl cellulose, sulfoethyl hydroxyethyl cellulose, sulfoethyl hydroxypropyl cellulose, carboxymethyl methyl hydroxyethyl cellulose, carboxymethyl methyl cellulose, sulfoethyl methyl hydroxyethyl cellulose, sulfoethyl methyl cellulose, carboxymethyl ethyl hydroxyethyl cellulose, carboxymethyl ethyl cellulose, sulfoethyl ethyl hydroxyethyl cellulose, sulfoethyl ethyl cellulose, carboxymethyl methyl hydroxypropyl cellulose, sulfoethyl methyl hydroxypropyl cellulose, carboxymethyl dodecyl cellulose, carboxymethyl dodecoyl cellulose, carboxymethyl cyanoethyl cellulose and sulfoethyl cyanoethyl cellulose, Non-limiting examples of nonionically suitable modified cellulose derivatives include methyl cellulose, ethyl cellulose, propyl cellulose, hydroxyethyl cellulose, hydroxypropyl cellulose, methyl hydroxyethyl cellulose, ethyl hydroxyethyl cellulose, dodecyl hydroxyethyl cellulose, ethyl hydroxypropyl cellulose, cellulose acetate, methyl hydroxypropyl cellulose, methyl ethyl hydroxyethyl cellulose, butyl glycidyl ether-hydroxyethyl cellulose, and lauryl glycidyl ether-hydroxyethyl cellulose

Specific examples include Finnfix BDA (from Noviant), Dencel DT (from Denkim, Denizli, Turkey), Tylose CR1500 G2 (from Clariant), Carbose codes D65, D72, LT-30 and LT-20 (from Penn Carbose); hydrophobically modified cellulose derivatives for example as described in U.S. Pat. No. 6,600,033 B1; cellulose derivatives modified with polyethylene glycol, for example as described in DE102004063766.

Enzymes—The cleaning compositions can comprise one or more enzymes which provide cleaning performance and/or fabric care benefits. Examples of suitable enzymes include, but are not limited to, hemicellulases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. The enzyme may also be a cellulase, wherein the ratio by mass of cellobiose dehydrogenase:cellulase is between 0.05 and 1000000. A typical combination is an enzyme cocktail that may comprise, for example, a protease and lipase in conjunction with amylase. When present in a cleaning composition, the aforementioned additional enzymes may be present at levels from about 0.00001% to about 2%, from about 0.0001% to about 1% or even from about 0.001% to about 0.5% enzyme protein by weight of the composition.

Photobleaches—The cleaning compositions can comprise one or more photobleaches which provide cleaning performance. Examples of suitable catalytic photobleaches are disclosed in USPA 2007/0191249 A1, which is incorporated herein by reference, and include xanthene dyes, sulfonated zinc phthalocyanine, sulfonated aluminium phthalocyanine, Eosin Y, Phoxine B, Rose Bengal, C.I. Food Red 14, photo-initiators selected from the group consisting of Aromatic 1,4-quinones such as anthraquinones and naphthaquinones; Alpha amino ketones, particularly those containing a benzoyl moiety, otherwise called alpha-amino acetophenones; Alpha-hydroxy ketones, particularly alpha-hydroxy acetophenones; Phosphorus-containing photoinitiators, including monoacyl, bisacyl and trisacyl phosphine oxide and sulphides; Dialkoxy acetophenones; Alpha-haloacetophenones; Trisacyl phosphine oxides; Benzoin and benzoin based photoinitiators, 2-ethyl anthraquinone; Vitamin K3; 2-sulphate-anthraquinone; 2-methyl 1-[4-phenyl]-2-morpholinopropan-1-one (Irgacure® 907); (2-benzyl-2-dimethyl amino-1-(4-morpholinophenyl)-butan-1-one (Irgacure® 369); (1-[4-(2-hydroxyethoxy)-phenyl]-2 hydroxy-2-methyl-1-propan-1-one) (Irgacure® 2959); 1-hydroxy-cyclohexyl-phenyl-ketone (Irgacure® 184); oligo[2-hydroxy 2-methyl-1-[4(1-methyl)-phenyl] propanone (Esacure® KIP 150); 2-4-6-(trimethylbenzoyl)diphenyl-phosphine oxide, bis(2,4,6-trimethylbenzoyl)-phenyl-phosphine oxide (Irgacure® 819); (2,4,6 trimethylbenzoyl)phenyl phosphinic acid ethyl ester (Lucirin® TPO-L); and mixtures thereof.

The aforementioned photobleaches can be used in combination (any mixture of photobleaches can be used). Suitable photobleaches can be purchased from Aldrich, Milwaukee, Wis., USA; Frontier Scientific, Logan, Utah, USA; Ciba Specialty Chemicals, Basel, Switzerland; BASF, Ludwigshafen, Germany; Lamberti S.p.A, Gallarate, Italy; Dayglo Color Corporation, Mumbai, India; Organic Dyestuffs Corp., East Providence, R.I., USA; and/or made in accordance with the examples contained herein.

Hueing dyes—The cleaning compositions can comprise one or more hueing dyes which can alter the tint of a surface as they absorb at least a portion of the visible light spectrum and thereby provide a consumer-preferred whiteness benefit. Examples of such hueing dyes are disclosed in USPA 2007/0129150 A1, which is incorporated herein by reference, and include dyes and dye-clay conjugates, and may also include pigments. Suitable hueing dyes include:
(a) Small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, such as Direct Violet Colour Index (Society of Dyers and Colourists, Bradford, UK) numbers Direct Violet 9, Direct Violet 35, Direct Violet 48, Direct Violet 51, Direct Violet 66, Direct Blue 1, Direct Blue 71, Direct Blue 80, Direct Blue 279, Acid Red 17, Acid Red 73, Acid Red 88, Acid Red 150, Acid Violet 15, Acid Violet 17, Acid Violet 24, Acid Violet 43, Acid Violet 49, Acid Blue 15, Acid Blue 17, Acid Blue 25, Acid Blue 29, Acid Blue 40, Acid Blue 45, Acid Blue 75, Acid Blue 80, Acid Blue 83, Acid Blue 90 and Acid Blue 113, Acid Black 1, Basic Violet 1, Basic Violet 3, Basic Violet 4, Basic Violet 10, Basic Violet 35, Basic Blue 3, Basic Blue 16, Basic Blue 22, Basic Blue 47, Basic Blue 66, Basic Blue 75, Basic Blue 159, Acid Violet 17, Acid Violet 43, Acid Red 73, Acid Red 88, Acid Red 150, Acid Blue 25, Acid Blue 29, Acid Blue 45, Acid Blue 113, Acid Black 1, Direct Blue 1, Direct Blue 71 and Direct Violet 51.
(b) Polymeric dyes include polymeric dyes selected from the group consisting of polymers containing conjugated chromogens (dye-polymer conjugates) and polymers with chromogens co-polymerised into the backbone of the polymer and mixtures thereof such as fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® (Milliken, Spartanburg, S.C., USA) Violet CT, carboxymethyl cellulose (CMC) conjugated with a reactive blue, reactive violet or reactive red dye such as CMC conjugated with C.I. Reactive Blue 19, sold by Megazyme, Wicklow, Ireland under the product name AZO-CM-CELLULOSE, product code S-ACMC and mixtures thereof.
(c) Dye clay conjugates include dye clay conjugates selected from the group comprising at least one cationic/basic dye and a smectite clay, and mixtures thereof.
(d) Pigments such as Ultramarine Blue (C.I. Pigment Blue 29), Ultramarine Violet (C.I. Pigment Violet 15) and mixtures thereof.

Suitable fabric hueing agents can be purchased from Aldrich, Milwaukee, Wis., USA; Ciba Specialty Chemicals, Basel, Switzerland; BASF, Ludwigshafen, Germany; Dayglo Color Corporation, Mumbai, India; Organic Dyestuffs Corp., East Providence, R.I., USA; Dystar, Frankfurt, Germany; Lanxess, Leverkusen, Germany; Megazyme, Wicklow, Ireland; Clariant, Muttenz, Switzerland; Milliken, Spartanburg, S.C., USA and Avecia, Manchester, UK.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo [6.6.2]hexadecane.

Suitable transition metal MRLs are readily prepared by known procedures, such as taught for example in WO 00/32601, and U.S. Pat. No. 6,225,464 B1.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

### Processes of Making Compositions

The compositions of the present invention can be formulated into any suitable form and prepared by any process chosen by the formulator, non-limiting examples of which are described in Applicants' examples and in U.S. Pat. No. 4,990,280; U.S. 2003/0087791 A1; U.S. 2003/0087790 A1; U.S. 2005/0003983 A1; U.S. 2004/0048764 A1; U.S. Pat. No. 4,762,636;U.S. Pat. No. 6,291,412 B1; U.S. 2005/0227891 A1; EP 1070115A2; U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; and U.S. Pat. No. 5,486,303.

### Method of Use

The present invention includes a method for cleaning and/or treating a situs inter alia a surface or fabric. Such method includes the steps of contacting an embodiment of Applicants' cleaning composition, in neat form or diluted in a wash liquor, with at least a portion of a surface or fabric then optionally rinsing such surface or fabric. The surface or fabric may be subjected to a washing step prior to the aforementioned rinsing step. For purposes of the present invention, washing includes but is not limited to, scrubbing, and mechanical agitation. As will be appreciated by one skilled in the art, the cleaning compositions of the present invention are ideally suited for use in laundry applications. Accordingly, the present invention includes a method for laundering a fabric. The method comprises the steps of contacting a fabric to be laundered with a said cleaning laundry solution comprising at least one embodiment of Applicants' cleaning composition, cleaning additive or mixture thereof. The fabric may comprise most any fabric capable of being laundered in normal consumer use conditions. The solution preferably has a pH of from about 8 to about 10.5. The compositions may be employed at concentrations of from about 500 ppm to about 15,000 ppm in solution. The water temperatures typically range from about 5° C. to about 90° C. The water to fabric ratio is typically from about 1:1 to about 30:1.

### EXAMPLES

Unless otherwise indicated, materials can be obtained from Aldrich, P.O. Box 2060, Milwaukee, Wis. 53201, USA.

### Example 1

### Production of Cellobiose Dehydrogenase Enzymes

Cellobiose dehydrogenase enzymes can be made as follows:

(a) Cellobiose dehydrogenase (CDH) from Sclerotium rolfsii
(i) Production of CDH from S. rolfsii

S. rolfsii CBS 191.62 can be obtained from the Centraalbureau voor Schimmelcultures, Baarn, The Netherlands. The organism is maintained through periodic transfer at 25° C. on glucose-maltose Sabouraud agar plates. Shaken flask cultures of S. rolfsii are grown at 30° C. with continuous agitation (110 rpm) in baffled 1000-ml Erlenmeyer flasks containing 500 ml of medium. The medium used for experimental cultures contains 30 gl⁻¹ α-cellulose, 20 gl⁻¹ Peptone, 20 gl⁻¹ Glutamate, 2.5 gl⁻¹ NH₄NO₃, MgSO₄.7H₂O, 0.6 mll⁻¹ KCl and 0.3 mll⁻¹ trace element solution (as per method described by Sachslehner, A. et al. “Production of Hemicellulose Degrading and Cellulose Degrading Enzymes by Various Strains of Sclerotium rolfsii.” Appl.Biochem.Biotech 63-65 (1997): 189-201.). The pH is adjusted to 5.0 using phosphoric acid before sterilisation. Several agar plugs cut from the actively growing, outer circumference of a fungal colony growing on Sabouraud plates are used as inocula. Inoculated flasks are cultivated for 7 days. Laboratory-scale cultivations are carried out in a 40-1 stirred tank bioreactor (MBR, Wetzikon, Switzerland) with a working volume of 301. The bioreactor is equipped with instrumentation for measurement and/or control of agitation, temperature, pH, dissolved oxygen concentration and foam. The culture medium is the same medium used for the shaken-flask cultivations and is sterilised in situ at 121° C. for 30 min. During the cultivation the temperature is maintained at 25° C. and the pH, which is initially adjusted to 5.0, is allowed to float. Agitation is constant at 100 rpm and aeration is held at 1.0 vol. air (fluid vol)⁻¹ min⁻¹. The precultures (10% vol. vol⁻¹) are 7-day-old shaken-flask cultures grown on the same medium used for the cultivation in the bioreactor.

After 10 days CDH activity can be detected using standard literature methods described in the assay section

(ii) Purification of CDH from S. rolfsii

Mycelium is separated by centrifugation (15 Min, 3000×g), the supernatant is filtered through a glass fiber filter (AP20, 75 mm Millipore, Billerica, USA) with pressure filtration and then concentrated using a 10 kDa Microza polysulfone ultrafiltration modul (Pall, New York, N.Y., USA). Crude extracts are further purified using a Q-Sepharose fast flow column from GE Healthcare, installed in an Amersham Pharmacia biotech ÄKTA purifier 900; Pump P-903; Monitor pH/Cond-900; Monitor UV-900; Autosampler Frac-900 (Amersham Biosciences Europe GmbH, Vienna, Austria), and pre-equilibrated with 50 mM sodium acetate buffer, pH 6.25. Before applying to the column the sample is diluted to a conductivity of below 10 mS and the pH is adjusted to 6.25 with sodium carbonate. The proteins are eluted with a linear salt gradient from 0-0.5 M NaCl in three column volumes. CDH-active fractions are pooled and concentrated again. The sample is then applied to DEAE Sepharose fast flow column (5×50 cm, Amersham Biosciences, Uppsala, Sweden) pre-equilibrated with 50 mM sodium actetate buffer pH 6.25. The proteins are eluted with the sample buffer and with a linear increasing concentration of buffer containing 1M NaCl in eight column volumes. Those fractions with CDH activity are pooled then applied to a Highload Superdex 5200 column (26/60 cm, Amersham) equilibrated with 100 mM sodium acetate buffer, pH 4.5, containing 200 mM NaCl, and eluted at 1 ml min⁻¹. Active fractions are again pooled and then applied to a 20 ml Q-Source column (1.6×10 cm, Amersham), which is equilibrated with 20 mM sodium acetate buffer, pH 4.5. The column is eluted by using a linear decreasing buffer gradient (20-1 mM sodium acetate buffer, pH 4.5, in 20 column volumes) The CDH-active fractions are again concentrated and used for further experiments (similar to method described by Baminger, U. et al. “Purification and characterization of cellobiose dehydrogenase from the plant pathogen Sclerotium (Athelia) rolfsii.” Applied and Environmental Microbiology 67.4 (2001): 1766-74.).

(b) Production and Purification of CDH from Myriococcum thermophilum

Myriococcum thermophilum CBS 389.69 can be obtained from the Centraalbureau voor Schimmelcultures, Baarn, The Netherlands. The organism is maintained at 37° C. through periodic transfer on glucose-maltose Sabouraud agar plates. Shaken flask cultures are grown at 40° C. with continuous agitation (110 rpm) in baffled 1000 mL Erlenmeyer flasks containing 500 mL of culture medium. The medium contains 20 g L⁻¹ a-cellulose, 5 g L⁻¹ peptone, 5 g L⁻¹ yeast extract, 1 gL⁻¹ MgSO₄.7H₂O and 0.3 mlL⁻¹ trace element solution. The pH is adjusted to pH 6.0 with phosphoric acid before sterilization. Several agar plugs cut from the growing part of a fungal colony are used as inocula. Inoculated flasks are cultivated for up to 10 days until activity of CDH can be measured.

Both the fermentation and the purification are described in Harreither, W. et al. “Investigation of graphite electrodes modified with cellobiose dehydrogenase from the ascomycete Myriococcum thermophilum.” Electroanalysis 19, 2-3 (2007): 172-80.

(c) Production and Purification of CDH from Humicola Insolens

Details of the synthesis and purification of this enzyme can be found in U.S. Pat. No. 6,033,981 which is herein incorporated by reference.

### (d) Standard Enzyme Assays.

Cellobiose Dehydrogenase enzyme activity can be measured using one or more of the following standard literature assays:

(i) 2,6-dichlorophenol-indophenol (DCIP) Assay

This measures cellobiose dehydrogenase activity by measuring the time-dependent reduction of 0.3 mM DCIP in 80 mM Na-acetate buffer, pH 4.0, containing 30 mM lactose and 20 mM NaF 20 μl sample at an absorption of 520 nm and 30° C. The extinction coefficient for DCIP at 520 nm and pH 4.0 is 7.3*10⁻³ M⁻¹ cm⁻¹. One unit of enzyme activity is defined as the amount of enzyme that reduces 1 μmol of DCIP per min under the selected assay conditions (pH 4.0, 30° C.). This assay is described in Baminger, U. et al. “A simple assay for measuring cellobiose dehydrogenase activity in the presence of laccase.” Journal of Microbiological Methods 35.3 (2002): 253-59.); and/or

(ii) Cytochrome c Assay

Alternatively, CDH activity can be selectively determined by following at 550 nm (30° C.) the reduction of 20 μM cytochrome c in 50 mM Na-succinate buffer, pH 3.5, containing 30 mM lactose. The extinction coefficient is 19.6 mM⁻¹ cm⁻¹. This method is described in the literature in Ludwig, R. and D. Haltrich. “Optimisation of cellobiose dehydrogenase production by the fungus Sclerotium (Athelia) rolfsii.” Applied Microbiology And Biotechnology 61.1 (2003): 32-39.)

### Examples 2-7

### Granular Laundry Detergent Compositions Designed for Handwashing or Top-Loading Washing Machines

| | 2 | 3 | 4 | 5 | 6 | 7 |
|---|---|---|---|---|---|---|
| | (wt %) | (wt %) | (wt %) | (wt %) | (wt %) | (wt %) |
| Linear alkylbenzenesulfonate | 20 | 22 | 20 | 15 | 20 | 20 |
| C₁₂₋₁₄ Dimethylhydroxyethyl | 0.7 | 1 | 1 | 0.6 | 0.0 | 0.7 |
| ammonium chloride | | | | | | |
| AE3S | 0.9 | 0.0 | 0.9 | 0.0 | 0.0 | 0.9 |
| AE7 | 0.0 | 0.5 | 0.0 | 1 | 3 | 1 |
| Sodium tripolyphosphate | 23 | 30 | 23 | 17 | 12 | 10 |
| Zeolite A | 0.0 | 0.0 | 0.0 | 0.0 | 10 | 0.0 |
| 1.6R Silicate (SiO₂:Na₂O at | 7 | 7 | 7 | 7 | 7 | 7 |
| ratio 1.6:1) | | | | | | |
| Sodium Carbonate | 15 | 14 | 15 | 18 | 15 | 15 |
| Polyacrylate MW 4500 | 1 | 0.0 | 1 | 1 | 1.5 | 1 |
| Carboxy Methyl Cellulose | 1 | 1 | 1 | 1 | 1 | 1 |
| Savinase ® 32.89 mg/g | 0.1 | 0.07 | 0.1 | 0.1 | 0.1 | 0.1 |
| Natalase ® 8.65 mg/g | 0.1 | 0.1 | 0.1 | 0.0 | 0.1 | 0.1 |
| Lipex ® 18 mg/g | 0.03 | 0.07 | 0.3 | 0.1 | 0.07 | 0.4 |
| Fluorescent Brightener 1 | 0.06 | 0.0 | 0.06 | 0.18 | 0.06 | 0.06 |
| Fluorescent Brightener 2 | 0.1 | 0.06 | 0.1 | 0.0 | 0.1 | 0.1 |
| Diethylenetriamine | 0.6 | 0.3 | 0.6 | 0.25 | 0.6 | 0.6 |
| pentaacetic acid | | | | | | |
| MgSO₄ | 1 | 1 | 1 | 0.5 | 1 | 1 |
| Sodium Percarbonate | 0.0 | 5.2 | 0.1 | 0.0 | 0.0 | 0.0 |
| Sodium Perborate Monohydrat | 4.4 | 0.0 | 3.85 | 2.09 | 0.78 | 3.63 |
| NOBS | 1.9 | 0.0 | 1.66 | — | 0.33 | 0.75 |
| TAED | 0.58 | 1.2 | 0.51 | — | 0.015 | 0.28 |
| Sulphonated zinc | 0.0030 | — | 0.0012 | 0.0030 | 0.0021 | — |
| phthalocyanine | | | | | | |
| S-ACMC | 0.1 | 0.06 | — | — | — | — |
| Direct Violet 9 | — | — | 0.0003 | 0.0005 | 0.0003 | — |
| Acid Blue 29 | — | — | — | — | — | 0.0003 |
| Cellobiose Dehydrogenase* | 0.003 | 0.002 | 0.006 | 0.004 | 0.003 | 0.02 |
| Sulfate/Moisture | Balance | Balance to | Balance to | Balance | Balance | Balance |
| | to 100% | 100% | 100% | to 100% | to 100% | to 100% |

*Refers to enzyme of this invention and the wt % is as active enzyme protein.

### Examples 8-11

### Granular Laundry Detergent Compositions Designed for Front-Loading Automatic Washing Machines

| | 8 | 9 | 10 | 11 |
|---|---|---|---|---|
| | (wt %) | (wt %) | (wt %) | (wt %) |
| Linear alkylbenzenesulfonate | 8 | 7.1 | 7 | 6.5 |
| AE3S | 0 | 4.8 | 0 | 5.2 |
| Alkylsulfate | 1 | 0 | 1 | 0 |
| AE7 | 2.2 | 0 | 3.2 | 0 |
| C₁₀₋₁₂ Dimethyl | 0.75 | 0.94 | 0.98 | 0.98 |
| hydroxyethylammonium chloride | | | | |
| Crystalline layered silicate (δ- | 4.1 | 0 | 4.8 | 0 |
| Na₂Si₂O₅) | | | | |
| Zeolite A | 20 | 0 | 17 | 0 |
| Citric Acid | 3 | 5 | 3 | 4 |
| Sodium Carbonate | 15 | 20 | 14 | 20 |
| Silicate 2R (SiO₂:Na₂O at ratio | 0.08 | 0 | 0.11 | 0 |
| 2:1) | | | | |
| Soil release agent | 0.75 | 0.72 | 0.71 | 0.72 |
| Acrylic Acid/Maleic Acid | 1.1 | 3.7 | 1.0 | 3.7 |
| Copolymer | | | | |
| Carboxymethylcellulose | 0.15 | 1.4 | 0.2 | 1.4 |
| Protease (56.00 mg active/g) | 0.37 | 0.4 | 0.4 | 0.4 |
| Termamyl ® (21.55 mg active/g) | 0.3 | 0.3 | 0.3 | 0.3 |
| Lipex ® (18.00 mg active/g) | 0.05 | 0.15 | 0.1 | 0.5 |
| Natalase ® (8.65 mg active/g) | 0.1 | 0.14 | 0.14 | 0.3 |
| TAED | 3.6 | 4.0 | 3.6 | 4.0 |
| Percarbonate | 13 | 13.2 | 13 | 13.2 |
| Na salt of Ethylenediamine-N,N′- | 0.2 | 0.2 | 0.2 | 0.2 |
| disuccinic acid, (S,S) isomer | | | | |
| (EDDS) | | | | |
| Hydroxyethane di phosphonate | 0.2 | 0.2 | 0.2 | 0.2 |
| (HEDP) | | | | |
| MgSO₄ | 0.42 | 0.42 | 0.42 | 0.42 |
| Perfume | 0.5 | 0.6 | 0.5 | 0.6 |
| Suds suppressor agglomerate | 0.05 | 0.1 | 0.05 | 0.1 |
| Soap | 0.45 | 0.45 | 0.45 | 0.45 |
| Sodium sulfate | 22 | 33 | 24 | 30 |
| Sulphonated zinc phthalocyanine | 0.0007 | 0.0012 | 0.0007 | — |
| (active) | | | | |
| S-ACMC | 0.01 | 0.01 | — | 0.01 |
| Direct Violet 9 (active) | — | — | 0.0001 | 0.0001 |
| Cellobiose dehydrogenase* | 0.001 | 0.004 | 0.02 | 0.002 |
| Water & Miscellaneous | Balance | Balance | Balance | Balance |
| | to 100% | to 100% | to 100% | to 100% |

*Refers to enzyme of this invention and the wt % is as active enzyme protein.

Any of the above compositions is used to launder fabrics at a concentration of 10,000 ppm in water, 20-90° C., and a 5:1 water:cloth ratio. The typical pH is about 10.

### Examples 12-17

### Heavy Duty Liquid Laundry Detergent Compositions

| | 12 | 13 | 14 | 15 | 16 | 17 |
|---|---|---|---|---|---|---|
| | (wt %) | (wt %) | (wt %) | (wt %) | (wt %) | (wt %) |
| AES C₁₂₋₁₅ alkyl ethoxy (1.8) | 11 | 10 | 4 | 6.32 | 6.0 | 8.2 |
| sulfate | | | | | | |
| Linear alkyl benzene | 4 | 0 | 8 | 3.3 | 4.0 | 3.0 |
| sulfonate | | | | | | |
| HSAS | 0 | 5.1 | 3 | 0 | 2 | 0 |
| Sodium formate | 1.6 | 0.09 | 1.2 | 0.04 | 1.6 | 1.2 |
| Sodium hydroxide | 2.3 | 3.8 | 1.7 | 1.9 | 2.3 | 1.7 |
| Monoethanolamine | 1.4 | 1.490 | 1.0 | 0.7 | 1.35 | 1.0 |
| Diethylene glycol | 5.5 | 0.0 | 4.1 | 0.0 | 5.500 | 4.1 |
| AE7 | 0.4 | 0.6 | 0.3 | 0.3 | 2 | 0.3 |
| Chelant | 0.15 | 0.15 | 0.11 | 0.07 | 0.15 | 0.11 |
| Citric Acid | 2.5 | 3.96 | 1.88 | 1.98 | 2.5 | 1.88 |
| C₁₂₋₁₄ dimethyl Amine | 0.3 | 0.73 | 0.23 | 0.37 | 0.3 | 0.225 |
| Oxide | | | | | | |
| C₁₂₋₁₈ Fatty Acid | 0.8 | 1.9 | 0.6 | 0.99 | 0.8 | 0.6 |
| Borax | 1.43 | 1.5 | 1.1 | 0.75 | 1.43 | 1.07 |
| Ethanol | 1.54 | 1.77 | 1.15 | 0.89 | 1.54 | 1.15 |
| Ethoxylated (EO₁₅) | 0.3 | 0.33 | 0.23 | 0.17 | 0.0 | 0.0 |
| tetraethylene | | | | | | |
| pentaimine¹ | | | | | | |
| Ethoxylated | 0.8 | 0.81 | 0.6 | 0.4 | 0.0 | 0.0 |
| hexamethylene | | | | | | |
| diamine² | | | | | | |
| 1,2-Propanediol | 0.0 | 6.6 | 0.0 | 3.3 | 0.0 | 0.0 |
| Protease* | 36.4 | 36.4 | 27.3 | 18.2 | 36.4 | 27.3 |
| Mannaway ®* | 1.1 | 1.1 | 0.8 | 0.6 | 1.1 | 0.8 |
| Natalase ®* | 7.3 | 7.3 | 5.5 | 3.7 | 7.3 | 5.5 |
| Lipex ®* | 10 | 3.2 | 0.5 | 3.2 | 2.4 | 3.2 |
| Liquitint ® Violet CT | 0.006 | 0.002 | — | — | — | 0.002 |
| (active) | | | | | | |
| S-ACMC | — | — | 0.01 | 0.05 | 0.01 | 0.02 |
| Cellobiose | 0.002 | 0.02 | 0.004 | 0.01 | 0.03 | 0.005 |
| Dehydrogenase** | | | | | | |
| Water, perfume, dyes & | Balance | Balance | Balance | Balance | Balance | Balance |
| other components | | | | | | |

*Numbers quoted in mg enzyme/100 g
**Refers to enzyme of this invention and the wt % is as active enzyme protein.
¹as described in U.S. Pat. No. 4,597,898.
²available under the tradename LUTENSIT ® from BASF and such as those described in WO 01/05874

### Example 18

### ADW Dual Phase Pouch

### Pouch Making Process:

The composition of Table 1 is introduced in a two compartment layered PVA rectangular base pouch. The dual compartment pouch is made from a Monosol M8630 film as supplied by Chris-Craft Industrial Products. 17.2 g of the particulate composition and 4 g of the liquid composition are placed in the two different compartments of the pouch. The pouch dimensions under 2 Kg load are: length 3.7 cm, width 3.4 cm and height 1.5 cm. The longitudinal/transverse aspect ratio is thus 1.5:3.2 or 1:2.47. The pouch is manufactured using a two-endless surface process, both surfaces moving in continuous horizontal rectilinear motion. According to this process a first web of pouches is prepared by forming and filling a first moving web of open pouches mounted on the first endless surface and closing the first web of open pouches with the second web of filled and sealed pouches moving in synchronism therewith.

TABLE 1

| | 18 |
|---|---|
| | (wt %) |
| Particulate composition | |
| C₁₄AO | 5 |
| SLF-18 Poly-Tergent ® | 5 |
| Hydroxyethane di phosphonate (HEDP) | 1 |
| Termamyl ® (21.55 mg active/g) | 1.5 |
| Protease (FN3)* | 2 |
| Sodium Percarbonate | 15 |
| Sodium Carbonate | 9 |
| Silicate 2R (SiO₂:Na₂O at ratio 2:1) | 6 |
| Perfume | 0.5 |
| Cellobiose Dehydrogenase* | 0.05 |
| Sodium tripolyphosphate and other adjuncts | Balance |
| | to 100% |
| Liquid composition | |
| FN3 Protease (48 mg active/g)* | 0.5 |
| Duramyl Liquid (44 mg active/g) | 0.5 |
| Dye | 0.5 |
| Dipropylene Glycol & other adjuncts | Balance |
| | to 100% |

*Refers to enzyme of this invention and the wt % is as active enzyme protein.

30,000 of the pouches described above and 1,800 L of distilled water at 70° C. are introduced in a Dryer Forberg (model FT 5000), the mixture is converted into a slurry, the slurry is then dried and granulated followed by separation with a 850 μm vibrating sieve. The powder which does not pass through the sieve is then ground in a Hammer Mill and reblended with the previously separated fraction. The resulting composition used to manufacture multi-compartment pouches according to the above described manufacturing process.

### Examples 19-22

### Automatic Dishwashing Compositions

| | 19 | 20 | 21 | 22 |
|---|---|---|---|---|
| Example # | (wt %) | (wt %) | (wt %) | (wt %) |
| Silicate 2R (SiO₂:Na₂O at ratio 2:1) | 8.98 | 9.85 | 8.98 | 8.0 |
| Anhydrous Sodium Carbonate | 20.00 | 20.00 | 30.00 | 25.0 |
| Methylglycinediacetic acid, trisodium salt¹ | — | — | 6.0 | 0-4.0 |
| Hydroxyethane di phosphonate (HEDP) | 0.23 | 0.23 | 0.23 | 0-0.23 |
| N,N-diacetic glutamic acid tetrasodium salt | — | — | 0-6.40 | 0-6.40 |
| Sodium Citrate | 17.00 | 20.00 | — | — |
| Co-polymer of acrylate & maleate (45%)² | 7.20 | 10.00 | 5.0-10.0 | 5.0 |
| SLF-18 Poly-Tergent ® | 1.00 | 2.00 | 2.0 | 1.0 |
| Polymer³ | 1.43 | 2.86 | — | — |
| FN3 Protease (123 mg active/g) | 0.19 | 0.28 | 0.16-0.28 | 0.19 |
| Termamyl ® (21.55 mg active/g) | 0.15 | 0.19 | 0.19-0.28 | 0.12 |
| CT_Blend Savinase/Natalase | 0.00 | 0.66 | 0.66 | — |
| Sodium Perborate Monohydrate | 3.17 | 4.25 | 4.0-4.25 | 3.60 |
| Sodium Sulfate (Anhydrous) | 37.75 | 27.66 | 35.39-40.70 | 46.98-49.38 |
| Cellobiose dehydrogenase* | 0.02 | 0.01 | 0.05 | 0.005 |
| Water, perfumes, dye, transition metal | Balance | Balance | Balance | Balance |
| bleach catalyst & hydroxyzincite | to 100% | to 100% | to 100% | to 100% |

¹Sold under tradename Trilon ® M by BASF, Ludwigshafen, Germany.
²One such suitable polymer would be sold under the tradename Aqualic TL by Nippon Shokubai, Japan.
³Sold under tradename Alcosperse 725 by Alco Chemical, Tennessee, USA.
*Refers to enzyme of this invention and the wt % is as active enzyme protein.

### Raw Materials and Notes for Composition Examples 2-22

Linear alkylbenzenesulfonate having an average aliphatic carbon chain length C₁₁-C₁₂ supplied by Stepan, Northfield, Ill., USA
C₁₂₋₁₄ Dimethylhydroxyethyl ammonium chloride, supplied by Clariant GmbH, Sulzbach, Germany
AE3S is C₁₂₋₁₅ alkyl ethoxy (3) sulfate supplied by Stepan, Northfield, Ill., USA
AE7 is C₁₂₋₁₅ alcohol ethoxylate, with an average degree of ethoxylation of 7, supplied by Huntsman, Salt Lake City, Utah, USA
Sodium tripolyphosphate is supplied by Rhodia, Paris, France
Zeolite A is supplied by Industrial Zeolite (UK) Ltd, Grays, Essex, UK
1.6R Silicate is supplied by Koma, Nestemica, Czech Republic
Sodium Carbonate is supplied by Solvay, Houston, Tex., USA
Polyacrylate MW 4500 is supplied by BASF, Ludwigshafen, Germany
Carboxy Methyl Cellulose is Finnfix® BDA supplied by CPKelco, Arnhem, Netherlands
Savinase®, Natalase®, Lipex®, Duramyl®, Termamyl®, Mannaway® supplied by Novozymes, Bagsvaerd, Denmark
Fluorescent Brightener 1 is Tinopal® AMS, Fluorescent Brightener 2 is Tinopal® CBS-X, Sulphonated zinc phthalocyanine and Direct Violet 9 is Pergasol® Violet BN-Z all supplied by Ciba Specialty Chemicals, Basel, Switzerland
Diethylenetriamine pentacetic acid is supplied by Dow Chemical, Midland, Mich., USA
Sodium percarbonate supplied by Solvay, Houston, Tex., USA
Sodium perborate is supplied by Degussa, Hanau, Germany
NOBS is sodium nonanoyloxybenzenesulfonate, supplied by Eastman, Batesville, Ark., USA
TAED is tetraacetylethylenediamine, supplied under the Peractive® brand name by Clariant GmbH, Sulzbach, Germany
S-ACMC is carboxymethylcellulose conjugated with C.I. Reactive Blue 19, sold by Megazyme,
Wicklow, Ireland under the product name AZO-CM-CELLULOSE, product code S-ACMC.
Soil release agent is Repel-o-tex® PF, supplied by Rhodia, Paris, France
Acrylic Acid/Maleic Acid Copolymer is molecular weight 70,000 and acrylate:maleate ratio 70:30, supplied by BASF, Ludwigshafen, Germany
Protease is FN3 supplied by Genencor International, Palo Alto, Calif., USA
Na salt of Ethylenediamine-N,N′-disuccinic acid, (S,S) isomer (EDDS) is supplied by Octel, Ellesmere Port, UK
Hydroxyethane di phosphonate (HEDP) is supplied by Dow Chemical, Midland, Mich., USA
Suds suppressor agglomerate is supplied by Dow Corning, Midland, Mich., USA
HSAS is mid-branched alkyl sulfate as disclosed in U.S. Pat. No. 6,020,303 and U.S. Pat. No. 6,060,443
C₁₂₋₁₄ dimethyl Amine Oxide is supplied by Procter & Gamble Chemicals, Cincinnati, Ohio, USA
Nonionic is preferably a C₁₂-C₁₃ ethoxylate, preferably with an average degree of ethoxylation of 9.
Protease is supplied by Genencor International, Palo Alto, Calif., USA
Liquitint® Violet CT is supplied by Milliken, Spartanburg, S.C., USA

### Other Abbreviations Used in Examples

Sodium: Sodium percarbonate of the nominal formula

### Percarbonate 2Na₂CO₃.3H₂O₂

C₁₄AO: tetradecyl dimethyl amine oxide

The dimensions and values disclosed herein are not to be understood as being strictly limited to the exact numerical values recited. Instead, unless otherwise specified, each such dimension is intended to mean both the recited value and functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising one or more adjunct ingredients, said one or more adjunct ingredients are selected from the group consisting of surfactants, builders, chelating agents, dye transfer inhibiting agents, dispersants, additional enzymes, and enzyme stabilizers, catalytic materials, bleaching agents, polymeric dispersing agents, clay soil removal/anti-redeposition agents, brighteners, suds suppressors, dyes, perfumes, structure elasticizing agents, fabric softeners, carriers, hydrotropes, processing aids, solvents, pigments, hueing agents, photobleaches, structurants, and mixtures thereof; and a cellobiose dehydrogenase enzyme said composition comprising, based on total composition weight, 0 weight % cellulase or said composition having a mass ratio of cellobiose dehydrogenase enzyme:cellulase of from about 0.01 to about 1,000,000; optionally said composition comprises a material selected from the group consisting of:
a) oligosaccharides selected from the group consisting of cello-oligosaccharides, lactose, maltose, xylobiose and mixtures thereof;
b) amorphous cellulose;
c) cellulosic polymers; and
d) mixtures thereof.

2. The composition of claim 1 wherein, said one or more adjunct ingredients comprises an enzyme and said composition comprises, based on total composition weight, 0 weight % cellulase or said composition has a mass ratio of cellobiose dehydrogenase enzyme:cellulase of from about 0.02 to about 500,000 optionally said composition comprises a material selected from the group consisting of:
a) a cello-oligosaccharides selected from the group consisting of cellobiose, cello-triose, cello-tetraose, cello-pentaose, cello-hexaose, cellodextrin and mixtures thereof, lactose, maltose, xylobiose and mixtures thereof;
b) amorphous cellulose;
c) carboxy methyl cellulose; and
d) mixtures thereof.

3. The composition of claim 1 wherein, said enzyme is selected from the group consisting of peroxidases, proteases, lipases, phospholipases, cellobiohydrolases, esterases, cutinases, pectinases, mannanases, pectate lyases, keratinases, reductases, oxidases, phenoloxidases, lipoxygenases, ligninases, pullulanases, tannases, pentosanases, glucanases, arabinosidases, hyaluronidase, chondroitinase, laccases, amylases, or mixtures thereof, said composition comprising, based on total composition weight, 0 weight % cellulase or said composition having a mass ratio of cellobiose dehydrogenase enzyme:cellulase of from about 0.05 to about 200,000.

4. The composition of claim 1 wherein, said enzyme is selected from the group consisting of:
a) lipases;
b) alpha-amylases;
c) endoglucanases,
d) proteases; and
e) mixtures thereof;
said composition comprising, based on total composition weight, 0 weight % cellulase or said composition having a mass ratio of cellobiose dehydrogenase enzyme:cellulase from about 0.1 to about 10,000.

5. The composition of claim 4 wherein:
a) said lipases, comprise lipases having greater than 90% amino acid sequence identity to SEQ. ID 8;
b) said alpha-amylases, comprise alpha-amylases having greater than 90% amino acid sequence identity to SEQ. ID 9;
c) said endoglucanases, comprise endoglucanases having greater than 90% amino acid sequence identity to SEQ. ID 10;
d) said proteases, comprise metalloproteases, neutral or alkaline serine proteases, and
e) mixtures thereof.

6. The composition of claim 5, wherein said proteases comprise subtilisins.

7. The composition of claim 6, wherein said subtilisins comprise a subtilisin derived from Bacillus lentus, B. alkalophilus, B. subtilis, B. amyloliquefaciens, and mixtures thereof.

8. The composition of claim 1 wherein said cellobiose dehydrogenase has a minimum of 60% amino acid sequence identity with the wild-type cellobiose dehydrogenases derived from a microorganism selected from the group consisting of Myceliophtore thermophila, Phanerochaete chrysosporium, Trametes versicolor, Grifola frondosa, Neosartorya fischeri, Humicola insolens, Sclerotium rolfsii, Myriococcum thermophilum and combinations thereof.

9. The composition of claim 1 wherein said cellobiose dehydrogenase has a minimum of 70% amino acid sequence identity with any enzyme having a sequence corresponding to a sequence ID selected from the group consisting of SEQ. ID Nos. 1, 2, 3, 4, 5, 6, or 7.

10. The composition of claim 9 wherein said cellobiose dehydrogenase enzyme has a minimum of 85% amino acid sequence identity with a sequence corresponding to a sequence ID selected from the group consisting of SEQ. ID Nos. 1, 2, or amino acids 22 to 785 of SEQ. ID No. 3.

11. The composition of claim 1 wherein said cellobiose dehydrogenase enzyme comprises a carbohydrate binding module.

12. The composition of claim 11 wherein said cellobiose dehydrogenase enzyme comprises a cellulose-binding domain.

13. The composition of claim 1 wherein said cellobiose dehydrogenase comprises a cellobiose dehydrogenase domain and a cellobiohydrolase domain.

14. A composition according to claim 1, said composition comprising a material selected from the group consisting of a surfactant, a polymer, a builder and mixtures thereof; said composition comprising, based on total product weight, less than about 15%, of said builder.

15. The composition of claim 14 wherein, said surfactant is selected from the group consisting of:
a) anionic surfactants;
b) non ionic surfactants;
c) amine oxides; and
d) mixtures thereof;
said polymer is selected from the group consisting of
a) polyacrylates;
b) maleic/acrylic acid copolymers;
c) cellulose-derived polymers;
d) polyethyleneimine polymers;
e) soil release polymers; and
f) mixtures thereof;
said builder is selected from the group consisting of
a) citric acid;
b) C₁₂-C₁₈ fatty acids;
c) aluminosilicates;
d) sodium tripolyphosphate; and
e) mixtures thereof;
said composition comprising, based on total product weight, less than about 10% of said builder.

16. A composition according to claim 15, wherein:
a) said anionic surfactants comprise anionic surfactants selected from the group consisting of linear alkylbenzene-sulfonate (LAS), alcohol ethoxysulfate (AES), mid-branched alkyl sulfates (HSAS) and mixtures thereof;
b) said non ionic surfactants comprise alcohol ethoxylates;
c) said cellulose-derived polymers, comprise cellulose-derived polymers selected from the group consisting of carboxymethylcellulose, methyl hydroxyethylcellulose and mixtures thereof;
d) soil release polymers, comprise co-polymers comprising two or more monomers selected from the group consisting of sulfo-isophthalate, ethylene terephthalate, oxyethyleneterephthalate and mixtures thereof;
e) said aluminosilicates comprise a zeolite;
said composition comprising, based on total product weight, less than about 8% of said builder.

17. A composition according to claim 16, wherein:
a) said alcohol ethoxylates comprise alcohol ethoxylates having a chain length of from 1 to 18 carbons;
b) said zeolite comprise Zeolite A, Zeolite X, Zeolite Y and mixtures thereof;
said composition comprising, based on total product weight, from 0.01% to 7% of said builder.

18. A composition according to claim 1, comprising a material selected from the group consisting of a photobleach, a fabric hueing agent and mixtures thereof.

19. A composition according to claim 18 wherein, said photobleach comprises a photo bleach selected from the group consisting of
a) xanthene dyes and mixtures thereof;
b) sulfonated zinc phthalocyanine, sulfonated aluminium phthalocyanine, Eosin Y, Phoxine B, Rose Bengal, C.I. Food Red 14 and mixtures thereof;
c) water soluble phthalocyanine; and
d) mixtures thereof;
and said fabric hueing agent comprises a fabric hueing agent selected from the group consisting of
a) dyes;
b) dye-clay conjugates comprising at least one cationic/basic dye and a smectite clay; and
c) mixtures thereof;
and mixtures thereof.

20. A composition according to claim 19 wherein, said dyes comprise dye selected from the group consisting of small molecule dyes, polymeric dyes and mixtures thereof.

21. A composition according to claim 1, said composition comprising a bleaching agent selected from one or more of the following:
a. a source of hydrogen peroxide;
b. a bleach activator, preferably tetraacetyl ethylene diamine (TAED) and/or nonanoyloxybenzene sulphonate (NOBS);
c. a pre-formed peracid;
d. a diacyl peroxide;
e. a tetraacyl peroxide; and
f. mixtures thereof;
and/or a bleach catalyst that is capable of accepting an oxygen atom from a peroxyacid and transferring the oxygen atom to an oxidizeable substrate.

22. A composition according to claim 21, wherein, said bleach activator comprises tetraacetyl ethylene diamine (TAED) and/or nonanoyloxybenzene sulphonate (NOBS).

23. A composition according to claim 1 comprising an encapsulated enzyme and/or an enzyme prill, preferably said encapsulated enzyme and/or enzyme prill comprising a cellobiose dehydrogenase enzyme.

24. A composition according to claim 23 wherein, said encapsulated enzyme and/or enzyme prill comprises a cellobiose dehydrogenase enzyme.

25. A method of treating and/or cleaning a surface or fabric comprising the steps of optionally washing and/or rinsing said surface or fabric, contacting said surface or fabric with a composition according to claim 1, then optionally washing and/or rinsing said surface or fabric.


SEQUENCE LISTING (10 sequences)

SEQ ID NO: 1 - protein, 828 aa, Myceliophtore thermophila
MRTSSRLIGALAAALLPSALAQNNAPVTFTDPDSGITFNTWGLAEDSPQTKGGFTFGVALPSDALTTDAKEFIGYLKCARNDESGWCGVSLGGPMTNSLLIAAWPHEDTVYTSLRFATGYAMPDVYQGDAEITQVSSSVNSTHFSLIFRCENCLQWSQSGATGGASTSNGVLVLGWVQAFADPGNPTCPDQITLEQHDNGMGIWGAQLNSDAASPSYTEWAAQATKTVTGDCGGPTETSVVGVPVPTGVSFDYIVVGGGAGGIPAADKLSEAGKSVLLIEKGFASTANTGGTLGPEWLEGHDLTRFDVPGLCNQIWVDSKGIACEDTDQMAGCVLGGGTAVNAGLWFKPYSLDWDYLFPSGWKYKDVQPAINRALSRIPGTDAPSTDGKRYYQQGFDVLSKGLAGGGWTSVTANNAPDKKNRTFSHAPFMFAGGERNGPLGTYFQTAKKRSNFKLWLNTSVKRVIRQGGHITGVEVEPFRDGGYQGIVPVTKVTGRVILSAGTFGSAKILLRSGIGPNDQLQVVAASEKDGPTMISNSSWINLPVGYNLDDHLNTDTVISHPDVVFYDFYEAWDNPIQSDKDSYLNSRTGILAQAAPNIGPMFWEEIKGADGIVRQLQWTARVEGSLGAPNGKTMTMSQYLGRGATSRGRMTITPSLTTVVSDVPYLKDPNDKEAVIQGIINLQNALKNVANLTWLFPNSTITPRQYVDSMVVSPSNRRSNHWMGTNKIGTDDGRKGGSAVVDLNTKVYGTDNLFVIDASIFPGVPTTNPTSYIVTASEHASARILALPDLTPVPKYGQCGGREWSGSFVCADGSTCQMQNEWYSQCL

SEQ ID NO: 2 - protein, 771 aa, Sclerotium rolfsii
MLSRLVLNLLAITVIGVFGQSSSSYTDNGINFQGITDPTYGVTYGAVFPPASVDSDEFIGEIAAPVAAKWIGLSLGGAMINNLLIVAWPNNNEIVFSSRYTTGYVLPTIYSGPKITTISSSVNSTHWKWIYRCQNCTTWSGGSLAANGSAVWAWAYSSAAVDTPSSPSSSFDEHTDFGFFGEITSNAHVSQSVYEQYLTGTGVTSTSSSTSTTTSTSTTTSTSSAPTVSATPYDYIIVGAGPAGIIAADRLSEAGKKVLLLERGGPSTKETGGTYTAPWAASSGLTKFDIPGVFESLFTDSNSFWWCKDITVFAGCLTGGGTAINGALYWYPTDLDFSTANGWPSSWTAHQKYTDLVSSRLPSSDHPSTDGKRYLEQSAAVVAQLLNGQGYRNKTINNAPNAKDHVYGYSAFDFLNGKRAGPVATYLQTAKTRNNFHFKNYVLVSNVVRNGSTITGVKTNDTSLGPNGVIPLTKNGRVILSAGSLSSPRILFQSGIGPTDMLTLVQNNPTASANLPSQSQWIHLPVGYNVADAPSINFVFTHPSIDAYDNWANVWTNPRSTDAEQYLKNQSGVLAASSPKLNFWRAYGGSDGRTRWMQGTVRPGAASINTTYNYNASQIFTITTYVSTGITSRGRIGVTSSLNVLPLVNPWLVDPVDEKVLTQSLEDLVSNMKSVPGLTMIMPDNTTSIADYVKNYDRASMNSNHWVGSNKIASNATEGVVDEHTKVFRTDNLFIVDASIIPSLPMGNPQGALMSAAEQAVAKILALAGGP

SEQ ID NO: 3 - protein, 785 aa, Humicola insolens
MKFLGRIGATALAASLYLTSGAAQATGDAYTDSETGIKFQTWSPDPQFTFGLALPPDALEKDATEYIGLLRCTRADPSDPGYCGLSHGQVGQMTQSLLLVAWAYENQVYTSFRYATGYTLPGLYTGNAKLTQLSVNITDTSFELIYRCENCFSWEHEGSTGSSSTSQGYLVLGRASARRGVVGPTCPDTATFGFHDNGFGQWGVGLENAVSEQYSEWASLPGLTVETTCEGSGPGEAQCVPAPEETYDYIVVGAGAGGIPVADKLSEAGHKVLLIEKGPPSTGRWQGTMKPEWLEGTDLTRFDVPGLCNQIWVDSAGIACTDTDQMAGCVLGGGTAVNAGLWWKPIDLDWDENFPEGWHSQDLAAATERVFERIPGTWHPSMDGKLYRDEGYKVLSSGLAESGWKEVVANEVPNEKNRTFAHTHFMFAGGERNGPLATYLVSADARENFSLWTNTAVRRAVRTGGKVTGVELECLTDGGYSGIVKLNEGGGVIFSAGAFGSAKLLFRSGIGPEDQLRVVASSKDGEDFIDEKDWIKLPVGYNLIDHLNTDLILTHPDVVFYDFYEAWTTPIEADKQLYLEQRSGILAQAAPNIGPMMWEQVTPSDGITRQFQWTARVEGDSRFTNSSHAMTLSQYLGRGVVSRGRATITQGLVTTVAEHPYLHNAGDKEAVIQGIKNLIESLNVIPNITWVLPPPGSTVEEYVDSLLVSASARRSNHWMGTAKLGTDDGRYGGTSVVDLDTKVYGTDNLFVVDASIFPGMSTGNPSAMIVIAAEQAAERILKLRK

SEQ ID NO: 4 - protein, 768 aa, Trametes versicolor
MKFKSLLLSLLPLVGSVYSQVAAPYVDSGNGFVFDGVTDPVHSVTYGIVLPQASTSTEFIGEFVAPNEAQWIGLALGGAMIGNLLLVAWPNGNKIVSSPRYATGYTLPAAYAGPTITQLPSSSVNSTHWKFVFRCQNCTAWNGGSIDPSGTGVFAWAFSNVAVDDPSDPNSSFAEHTDFGFFGINFPDAQSSNYQNYLAGNAGTPPPTSVPSGPSSTTTTTGPTATATPFDYIVVGAGPGGLVTADRLSEAGKKVLLLERGGPSTAETGGTYDATWAKSANLTKFDVPGLFETLFTDTNPFWWCKDTNFFAGCLLGGGTSVNGALYWYPNSRDFSTASGWPSSWSNHQPFTDKLKQRLPSTDHPSADGQRYLEQSATVVQQLLSGQGYSQITINGNPDSKDHVFGFSAFDFLNGQRAGSVATYFETALARKNFVYKDNVLVTQVIRNGSTILGVRTNDNTLGPDGVVPLNPNGRVILSGGSFGTPRILFQSGIGPTDMLQTVQSNAQAAANLPPQSEWIDLPVGQSVSDNPSINLVFTHPSIDAYDNWADVWSNPRPADAQQYLQSRSGVLAGASLKLNFWRAYGGSDGITGYAQGTVRPGAASVNTSVAYNASEIFTTTLYLSNGIQSRGRIGVDATLNAKALVNPWLTNSVDKTVLLQALHDVTSTMKNVSGLTMITPDNTMTLEQYVAAYDPATMCSNHWVGAAKMGTSSSTAVVDENAKVFNTDNLFIVDASIIPSLPIGNPQGVLMSAAEQAVSRILALAGGP

SEQ ID NO: 5 - protein, 773 aa, Phanerochaete chrysosporium
MLGRSLLALLPFVGLAFSQSASQFTDPTTGFQFTGITDPVHDVTYGFVFPPLATSGAQSTEFIGEVVAPIASKWIGIALGGAMNNDLLLVAWANGNQIVSSTRWATGYVQPTAYTGTATLTTLPETTINSTHWKWVFRCQGCTEWNNGGGIDVTSQGVLAWAFSNVAVDDPSDPQSTFSEHTDFGFFGIDYSTAHSANYQNYLNGDSGNPTTTSTKPTSTSSSVTTGPTVSATPYDYIIVGAGPGGIIAADRLSEAGKKVLLLERGGPSTKQTGGTYVAPWATSSGLTKFDIPGLFESLFTDSNPFWWCKDITVFAGCLVGGGTSVNGALYWYPNDGDFSSSVGWPSSWTNHAPYTSKLSSRLPSTDHPSTDGQRYLEQSFNVVSQLLKGQGYNQATINDNPNYKDHVFGYSAFDFLNGKRAGPVATYLQTALARPNFTFKTNVMVSNVVRNGSQILGVQTNDPTLGPNGFIPVTPKGRVILSAGAFGTSRILFQSGIGPTDMIQTVQSNPTAAAALPPQNQWINLPVGMNAQDNPSINLVFTHPSIDAYENWADVWSNPRPADAAQYLANQSGVFAGASPKLNFWRAYSGSDGFTRYAQGTVRPGAASVNSSLPYNASQIFTITVYLSTGIQSRGRIGIDAALRGTVLTPPWLVNPVDKTVLLQALHDVVSNIGSIPGLTMITPDVTQTLEEYVDAYDPATMNSNHWVSSTTIGSSPQSAVVDSNVKVFGTNNLFIVDAGIIPHLPTGNPQGTLMSAAEQAAAKILALAGGP

SEQ ID NO: 6 - protein, 768 aa, Grifola frondosa
MFGHLLLALLPLVGSAFAQSGSIYTDPGNGFTFDGITDPVYDVTYGVIFPTDTTSTEFIGEIVAPVAAQWIGVALGGAMIDNLLLVVWTNGNTIVSSTRYATDYIQPVPYAGPTLTTLPSSSVNSTHWKFVFRCQNCTSWLGGGSIPVSGSGVLAWAYSSIPVDDPADPNSDFLEHTDFGFFGMNFADAHTSNYNNYLNGNAGTSTPPTGSPTTTTTSPTTGPTTPATPYDYVIVGAGPGGIIAADRLSEAGKKVLLLERGGPSTGETGGTYTAPWAAGTNLTKFDIPGLFESMFTDSNPWYWCKDINFFAGCLLGGGTSVNGALYWYPTDSDFSTNNGWPNSWGYHQPYTSAMQARLPSTDHPSTDGQLYLEQSANVVMQLLNGQGYRQVTINNDVNSKDHVYGYSAFDFLNGKRGGPVATYLQTANARSNFVYKDYTMVSNIVRNGSQITGVKTNDTSLGPNGVVPLTPNGRVILSAGSFGSPRILFQSGIGPTDMLQTVQGNPAAAPNLPPQSEWINLPVGMAVSDNPSINLVFTHPSIDAYDNWADVWSDPRPADAAQYLASQSGVFAGASPKLNFWRAYSGIDANQRWAQGTVRPGAASVNTTLPYNASEIFTITVYLSQGITSRGRIGINAGLEATALVNPWLTDPVDKTVLIQALNDVVSNMNSISGLTMITPDSGMTIEEYVDLYDPGTMCSNHWVGSNKMGTNSSTAVVDENAKVFNTNNLFVVDASIIPALPVGNPHGMLMSAAEQAVANILALAGGP

SEQ ID NO: 7 - protein, 777 aa, Irpex lacteus
MLRRTLLALLPLIGTALSQSASNYIDPDNGFQFTGVTDAETQVTYGVTFPPLATSGAQSTEFIGEVVAPVAAKWVGIALAGAMLQDLLLVAWPNAGKIVSSTRIASDYVQPTAYTGAATLTTLPETTVNATHWKWVFRCQGCTSWTSPSGSTGSISVDGSGVLAWAYSSVGVDDPTDPESTFQEHTSFGFFGIDYSQAHTSNYQNYLDGNPGTPTSAPSGPSSTTTTVPTGPTTPAVAYDYIVVGAGPGGIIAADRLSEAGKKVLLLERGGPSTKVTGGTYVPSWAGSTGLTKFDIPGVFESMFTDSNPFWWCKDVTVFAGCLIGGGTSINGALYWYPNSDDFSTAAGWPSSWTNHGPYTAKLKARLPSTDHPSADGKRYLEQTADLVGQLLKGQGYSNITINDNPDYKDHVYGYAAYDFLGGLRGGPVATYLQTALARPNFTLKQYTLVTNVVRNGSTITGVQTNDTSLGPNGIIPLTKNGRVILAAGSLQTPRLLFQSGIGPTDQINLVKGNTDAASRLPPQSDWINLPVGYNAQDNPSINLVFTHPSIDAYDNWADVWTNPPSADVAQYLGSRSGILASASPRLNFWRAYGGSDGVVRYAQGTVRPGAASVNTTLPYNASNIFTITVYLSTGIQSRGRVGIDASLRAKPLVNPWLVDPVDKQVLLQALNDVVSNIKSIQNLTLITPDVHQTIEEYVDAYDPATMNSNHWVSTATIGTSASNAVVDQNTKVFNTNNLFIVDASIIPHLPVGNPHGALMSAAEQAAAKILALAGGP

SEQ ID NO: 8 - protein, 269 aa, Thermomyces lanuginosus
EVSQDLFNQFNLFAQYSAAAYCGKNNDAPAGTNITCTGNACPEVEKADATFLYSFEDSGVGDVTGFLALDNTNKLIVLSFRGSRSIENWIGNLNFDLKEINDICSGCRGHDGFTSSWRSVADTLRQKVEDAVREHPDYRVVFTGHSLGGALATVAGADLRGNGYDIDVFSYGAPRVGNRAFAEFLTVQTGGTLYRITHTNDIVPRLPPREFGYSHSSPEYWIKSGTLVPVRRRDIVKIEGIDATGGNNQPNIPDIPAHLWYFGLIGTCL

SEQ ID NO: 9 - protein, 484 aa, Bacillus strain NCIB 12513
HHNGTNGTMMQYFEWHLPNDGNHWNRLRDDASNLRNRGITAIWIPPAWKGTSQNDVGYGAYDLYDLGEFNQKGTVRTKYGTRSQLESAIHALKNNGVQVYGDVVMNHKGGADATENVLAVEVNPNNRNQEISGDYTIEAWTKFDFPGRGNTYSDFKWRWYHFDGVDWDQSRQFQNRIYKFRGDGKAWDWEVDSENGNYDYLMYADVDMDHPEVVNELRRWGEWYTNTLNLDGFRIDAVKHIKYSFTRDWLTHVRNATGKEMFAVAEFWKNDLGALENYLNKTNWNHSVFDVPLHYNLYNASNSGGNYDMAKLLNGTVVQKHPMHAVTFVDNHDSQPGESLESFVQEWFKPLAYALILTREQGYPSVFYGDYYGIPTHSVPAMKAKIDPILEARQNFAYGTQHDYFDHHNIIGWTREGNTTHPNSGLATIMSDGPGGEKWMYVGQNKAGQVWHDITGNKPGTVTINADGWANFSVNGGSVSIWVK

SEQ ID NO: 10 - protein, 773 aa, Bacillus sp AA439
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE